(19) United States
(12) Patent Application Publication
(10) Pub. No.: US 2026/0113609 A1
(43) Pub. Date: Apr. 23, 2026

(54) METHODS AND SYSTEMS FOR EMERGENCY DATA TRANSMISSION

(71) Applicant: T-Mobile Innovations LLC, Overland Park, KS (US)

(72) Inventor: Hang Hoi YAU, Sammamish, WA (US)

(21) Appl. No.: 18/921,533

(22) Filed: Oct. 21, 2024

(51) Int. Cl. H04W 4/90; H04L 65/1016; H04L 65/1104

(52) U.S. Cl. CPC H04W 4/90; H04L 65/1016; H04L 65/1104

(57) ABSTRACT

Systems, methods and devices are provided. The method includes generating device data and transmitting, by the wireless device, a call request and the device data to a public safety answering point (PSAP) using a wireless network. The system includes a computing device communicatively connected to a wireless network, wherein the computing device comprises at least one processor configured to generate device data and transmit a call request and the device data to a PSAP using the wireless network.

### TECHNICAL BACKGROUND

Computing devices, such as smartphones, are often used for placing calls to emergency services. In some circumstances, the person placing the call may be in a situation where the person cannot relay important information that could be helpful in providing aid, such as information related to the person’s surrounding or the person’s health during the call.

### OVERVIEW

Exemplary embodiments described herein include systems, methods, and processing nodes for emergency wireless device location transmission. An exemplary method includes generating device data and transmitting a call request and the device data to a public safety answering point (PSAP) using a wireless network.

Further exemplary embodiments include a system for emergency wireless device location transmission. The system includes a wireless network. The system additionally includes a computing device including a processor configured to generate device data and transmit a call request and the device data to a public safety answering point (PSAP) using the wireless network.

In yet a further exemplary embodiment, a non-transitory computer readable medium is provided. The non-transitory computer-readable medium stores instructions, when executed by a processor, configuring the processor to generate device data and transmit a call request and the device data to a public safety answering point (PSAP) using the wireless network.

### BRIEF DESCRIPTION OF THE DRAWINGS

FIG. 1 illustrates an exemplary system for transmitting device data in accordance with disclosed embodiments.

FIG. 2 is a block diagram illustrating an exemplary system for transmitting device data in an emergency.

FIG. 3 illustrates a flow chart of an emergency device data transmission in accordance with disclosed embodiments.

FIG. 4 illustrates an exemplary method for emergency device data transmission in accordance with disclosed embodiments.

FIG. 5 illustrates an example of a processing node in accordance with aspects of this disclosure.

FIG. 6 illustrates an example of a computing device in accordance with aspects of this disclosure.

### DETAILED DESCRIPTION

During an emergency call placed using a smartphone, or other wireless computing devices, data related to the person and the surroundings related to the emergency may be gathered by the device. For example, the device may be able to gather biometric information of the user or data related to the device’s movement during the call.

As modern systems implement voice over IP for emergency calls, data generated by the device placing the call can be sent to emergency services during the call. For example, during the emergency call, data from sensors, including sensors of the device placing the call and devices connected to the device placing the call, may be transmitted to a public safety answering point (PSAP), such as a PSAP implementing a Next Gen 911 system, to be used for helping aid in the emergency.

As the operator at the PSAP tries to locate and provide assistance to the person, the data that is provided during the call may help in understanding the surroundings of the person and providing guidance to that person. For example, atmospheric pressure data, such as data from a barometer, may aid the operator in understanding the rate at which the environment where the call is being paced, in the case of a fire, is worsening, such as due to sudden pressure changes caused by explosions. In some situations where the person placing the call becomes unconscious, the data provided to the operator may be vital in the aid.

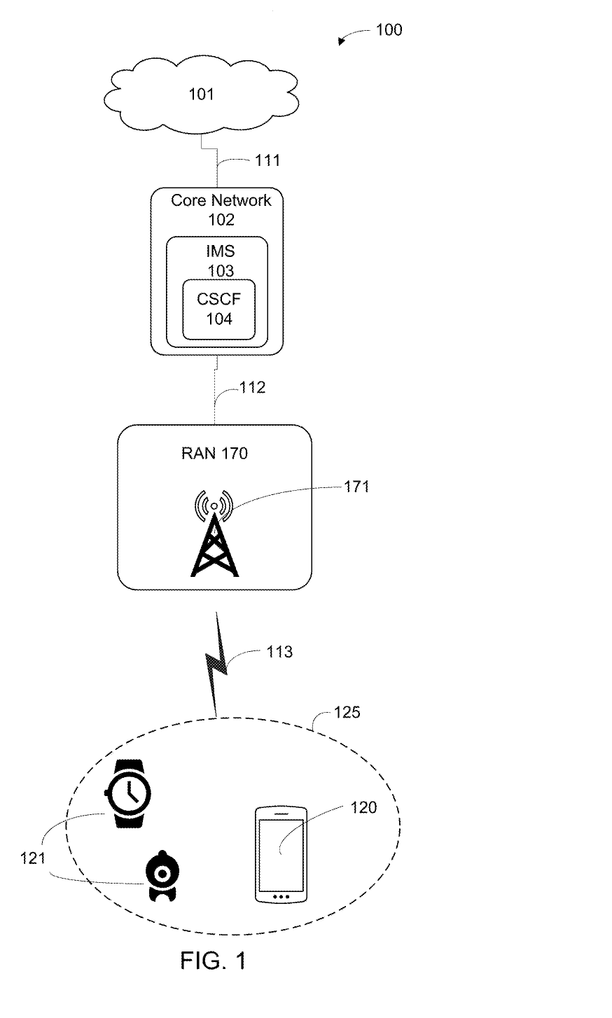

These and other examples will be described in greater detail below in relation to FIGS. 1-6.

FIG. 1 depicts an exemplary system 100 for device data transmission. System 100 includes a communication network 101, a core network 102 and a radio access network (RAN) 170, including at least one access node 171.

Core network 102 is connected to communication network 101 over communication link 111. Core network 102 includes an IP multimedia subsystem (IMS) 103. IMS 103 as used herein is a framework used for delivering IP multimedia services, such as voice over IP (VoIP) and real-time transport protocol (RTP), across a network. IMS 103 includes a call session control function (CSCF) 104. CSCF 104 as used herein is a component of IMS 103 used for session control, signaling and routing in multimedia communication. In embodiments, CSCF 104 is used for handling SIP communication. In embodiments, IMS 103 may be used for communication between entities or components of network 101 and wireless device 120. For example, CSCF 104 may be used for transmitting SIP communication to wireless device 120. IMS 103 may also include an application server (AS). For example, AS may be used for formatting device data, such as biometric data, in a format that can be received by a receiving entity.

The RAN 170 may include other devices and additional nodes not described herein. For example, RAN 170 may include devices used for forwarding SMS messages from wireless device 120 to core network 102. In some embodiments, RAN 170 may include devices used for forwarding device data from wireless device 120 to core network 102.

RAN 170 is connected to core network 102 over communication link 112.

System 100 also includes a wireless device 120. In embodiments, system 100 may include multiple wireless devices. Wireless device 120 is configured to operate in one or more coverage areas 125. Wireless device 120 may be an end-user wireless device. Wireless device 120 may include any device configured to send and receive messages over SIP. Wireless device 120 may include any device configured to generate device data such as sensor data. In embodiments, sensor data may include data generated based on user data and environmental data sensors. User data sensors may include sensors configured to detect data related to the wireless device, and user interaction with the device. For example, user data sensors may include accelerometers, gyroscopes, proximity sensors, touchscreen sensors, fingerprint sensors, face recognition sensors, and the like. Environmental data sensors may include sensors configured to capture data related to the environment within and around the wireless device. For example, environmental data sensors may include ambient light sensors, thermometers, hygrometers, air quality sensors, ultraviolet (UV) sensors, global position systems (GPS), barometers, and the like.

In some embodiments, wireless device 120 may be configured to generate device data using sensors coupled to external devices 121. As used herein, external device 121 is a computing device not directly connected to core network 102 that is configured to be communicatively connected to wireless device 120. For example, sensors used for generating device data may be coupled to external devices 121 such as smartwatches, fitness trackers, webcams, and the like. For example, wireless device 120 may be connected to an external device 121, such as a smartwatch, which is used for sending biometric information of a user to the wireless device 120, which subsequently is used to send the biometric information to an entity, or component, within network 101 through RAN 170 and core network 102. It should be noted that in some examples, wireless device 120 may include a smartwatch that is capable of connecting to core network 102, while in other examples external device 121 may include a smartwatch that is configured to only connect to a wireless device 120, such as a smartphone. In embodiments, wireless device 120 communicates with RAN 170 over communication link 113. Examples of communication link 113 may include a 6G network link, 5G network link, 4G LTE network link, and the like.

Communication network 101 may be wired and/or wireless communication network. In embodiments, communication network 101 may include processing nodes, routers, gateways, physical and/or wireless data links for carrying data among various network elements, including combinations thereof. In embodiments, communication network 101 may include a local area network, a wide area network, an inter-network, such as the internet, and the like. Communication network 101 may be capable of carrying data, such as, for example, to support multimedia files, and data communications by wireless device 120. Wireless network protocols can include multimedia broadcast multicast service (MBMS), code division multiple access (CDMA) 1xRTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), Worldwide Interoperability for Microwave Access (WiMAX), Fourth Generation broadband cellular (4G, LTE Advanced, etc.), and Fifth Generation mobile network or wireless system (5G, 5G New Radio (“5G NR”), or 5G LTE), 6G and/or non-terrestrial network protocols. Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 may also include additional base stations, controller nodes, telephony switches, internet routers, network gateways, computer systems, communication links, or some other type of communication equipment, and combinations thereof.

The core network 102 includes core network functions and elements. The core network 102 may have an evolved packet core (EPC) or may be structured using a service-based architecture (SBA). The network functions and elements may be separated into user plane functions and control plane functions. In an SBA architecture, service-based interfaces may be utilized between control-plane functions, while user-plane functions connect over point-to-point link. The user plane function (UPF) accesses a data network, such as network 101, and performs operations such as packet routing and forwarding, packet inspection, policy enforcement for the user plane, quality of service (QoS) handling, etc. The control plane functions may include, for example, a network slice selection function (NSSF), a network exposure function (NEF), a network repository function (NRF), a policy control function (PCF), a unified data management (UDM) function, an application function (AF), an access and mobility function (AMF), an authentication server function (AUSF), and a session management function (SMF). Additional or fewer control plane functions may also be included. The AMF receives connection and session related information from the wireless devices 120 and is responsible for handling connection and mobility management tasks. The SMF is primarily responsible for creating, updating, and removing sessions and managing session context. The UDM function provides services to other core functions, such as the AMF, SMF, and NEF. The UDM may function as a stateful message store, holding information in local memory. The NSSF can be used by the AMF to assist with the selection of network slice instances that will serve a particular device. Further, the NEF provides a mechanism for securely exposing services and features of the core network.

Although one core network 102 is shown, multiple core networks 102 may be utilized. Alternatively, the single core network 102 may include a distributed, cloud-native, converged core gateway. For example, the converged core gateway could connect a 4G LTE evolved packet core (EPC) to a 5G core network.

Communication links 111 and 112 can use various communication media, such as air, space, metal, optical fiber, or some other signal propagation path, including combinations thereof. Communication links 111 and 112 can be wired or wireless and use various communication protocols such as Internet, Internet protocol (IP), local-area network (LAN), S1, optical networking, hybrid fiber coax (HFC), telephony, T1, or some other communication format—including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, 6G or combinations thereof. Other wireless protocols can also be used. Communication links 111 and 112 can be direct links or might include various equipment, intermediate components, systems, and networks, such as a cell site router, etc. Communication links 111 and 112 may comprise many different signals sharing the same link.

In embodiments, RAN 170 may include various access network systems and devices such as access node 171. The RAN 170 is disposed between the core network 102 and the end-user wireless devices 120. Components of the RAN 170 may communicate directly with the core network 102 and others may communicate directly with the end user wireless devices 120. The RAN 170 may provide services from the core networks 102 to the end-user wireless devices 120.

The RAN 170 includes at least an access node (or base station) 171 such as an eNodeB or gNodeB communicating with the plurality of end-user wireless devices 120. In embodiments, access node 171 includes a unique identifier. It is understood that the disclosed technology may also be applied to communication between an end-user wireless device and other network resources, such as relay nodes, controller nodes, antennas, etc. Further, multiple access nodes may be utilized. For example, some wireless devices may communicate with an LTE eNodeB and others may communicate with an NR gNodeB.

Access node 171 can be, for example, standard access nodes such as a macro-cell access node, a base transceiver station, a radio base station, an eNodeB device, an enhanced eNodeB device, a gNodeB in 5G New Radio (“5G NR”), or the like. The gNBs may include, for example, centralized units (CUs) and distributed units (DUs).

In additional embodiments, access nodes may comprise two co-located cells, or antenna/transceiver combinations that are mounted on the same structure. Alternatively, access node 171 may comprise a short range, low power, small-cell access node such as a microcell access node, a picocell access node, a femtocell access node, or a home eNodeB device. As will be further described below, functionality for emergency navigational pathing may be included within the access nodes.Access node 171 can be configured to deploy one or more different carriers, utilizing one or more RATs. For example, a gNodeB may support NR and an eNodeB may provide LTE coverage. It would be evident to one of ordinary skill in the art, in light of this disclosure, the many other combinations of access nodes and carriers that could be deployed.

The access nodes 171 may include a processor and associated circuitry to execute or direct the execution of computer-readable instructions to perform operations such as those further described herein. Access nodes can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

The wireless devices 120 may include any wireless device included in a wireless network. For example, the term “wireless device” may include a relay node, which may communicate with an access node. The term “wireless device” may also include an end-user wireless device, which may communicate with the access node 171 through the relay node. The term “wireless device” may further include an end-user wireless device that communicates with the access node 171 directly without being relayed by a relay node.

Wireless devices 120 may be any device, system, combination of devices, or other such communication platform capable of communicating wirelessly with access network 171 using one or more frequency bands and wireless carriers deployed therefrom. Each of wireless devices 120, may be, for example, a mobile phone, a wireless phone, a wireless modem, a personal digital assistant (PDA), a voice over internet protocol (VoIP) phone, a voice over packet (VOP) phone, or a soft phone, an internet of things (IoT) device, as well as other types of devices or systems that can send and receive audio or data. The wireless devices 120 may be or include high power wireless devices or standard power wireless devices. Other types of communication platforms are possible.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork, such as the internet. System 100 may be capable of communicating signals and carrying data, for example, to support voice, push-to-talk, broadcast video, and data communications by end-user wireless devices 120. System 100 may include additional base stations, controller nodes, telephony switches, internet routers, network gateways, computer systems, communication links, or other type of communication equipment, and combinations thereof.

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between the RAN 170 and the core network 102.

The methods, systems, devices, networks, access nodes, and equipment described herein may be implemented with, contain, or be executed by one or more computer systems and/or processing nodes. The methods described above may also be stored on a non-transitory computer readable medium. Many of the elements of system 100 may be, comprise, or include computers systems and/or processing nodes, including access nodes, controller nodes, and gateway nodes described herein.

The operations for emergency wireless device data transmission may be implemented as computer-readable instructions or methods, and processing nodes on the network and/or computing device, such as end user wireless device, for executing the instructions or methods. The processing node may include a processor included in the access node or a processor included in any controller node in the wireless network that is coupled to the access node. The computing device may include at least a processor and a memory with instructions configuring the processor to execute instructions.

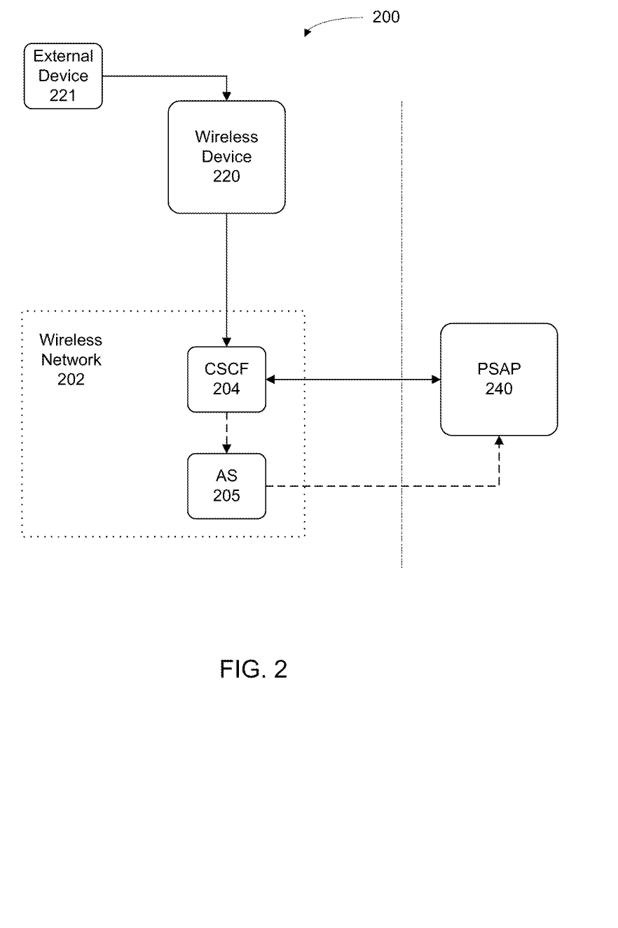

Now referring to FIG. 2, an exemplary system 200 for transmitting device data is presented. System 200 includes a wireless device 220. In embodiments, system 200 may include an external device 221 communicatively coupled to wireless device 220. Wireless device 220 and external device 221 may be the same as wireless device 120 and external device 121, respectively. System 200 also includes wireless network 202. Wireless network 202 may include a RAN, core network and/or a communication network, which may be the same as, respectively, RAN 170, core network 102 and communication network 101. Wireless network 202 includes services and components used by a wireless network for handling voice and data transmission to emergency services. For example, wireless network 202 may include base transceiver station traffic channels (TCH), packet data channels (PDCH) and control channels (CCH) used for transmitting. Wireless network 202 also includes CSCF 204 which may be the same as CSCF 104. Wireless network 202 may also include an application server (AS) 205. It should be noted that CSCF 204 and AS 205 are provided as examples for ease of description. As such, system 200 may include other components for performing the steps described, which are not described herein. For example, a media resource function (MRF) component may be included for processing and handling media streams.

The system 200 also includes a public safety answering point (PSAP) 240. The PSAP 240 may include any emergency answering service capable of receiving multimedia messages including text messages, such as messages using SIP. Wireless Network 202 connects to PSAP 240 through a communication link. The communication link may include communication link 111 described in reference to FIG. 1. PSAP 240 may be equipped with a Next Generation 911 (NG911) system capable of receiving text, video and data in a plurality of formats. In embodiments, PSAP 240 and wireless network 202 may be configured to communicate over an emergency services IP network (ESInet). In some embodiments, PSAP 240 may include an application server (AS) for processing device data from wireless device 220. In some embodiments, PSAP 240 and wireless network 202 may be configured to communicate using an IP multimedia subsystem (IMS) of the wireless network 202, which may include IMS 103. It is noted that PSAP 240 and wireless networks 202 may alternatively or concurrently communicate over other network architectures not described herein.

In this example system 200, wireless network 202 may handle the processing of device data through AS 205 or PSAP 240 may handle the processing, if PSAP 240 includes an application server configured for processing the device data. For example, if PSAP 240 includes an application server, system 200 may use the PSAP 240 application server instead of AS 205 as to reduce latency and, in some cases, faster processing of the data.

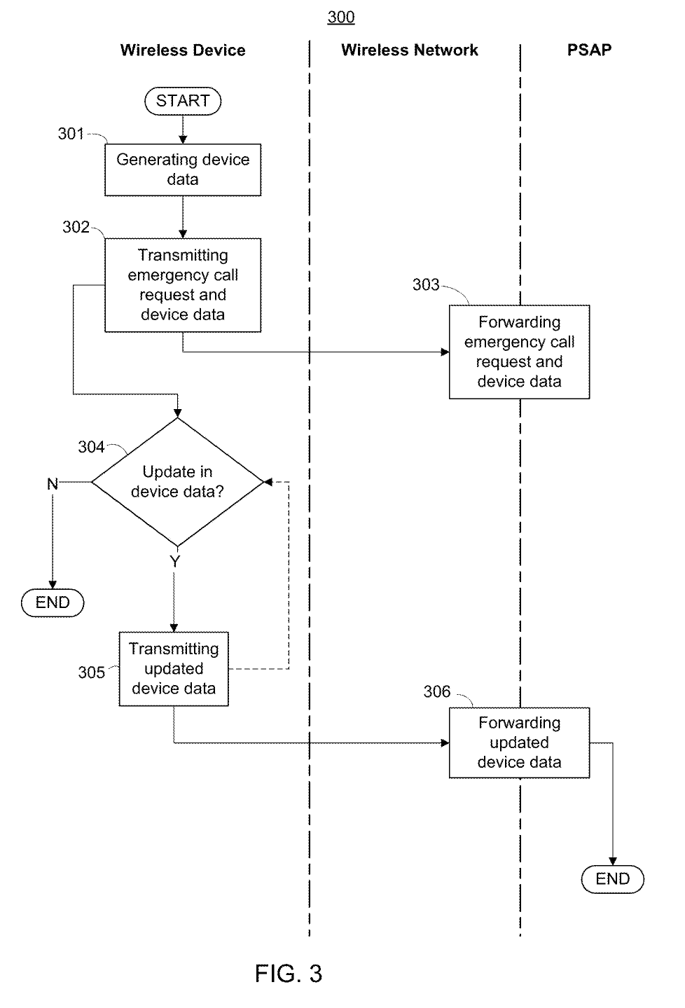

As it will be described in more detail in reference to FIG. 3, wireless device transmits a VoIP call to PSAP 240, which in this example is handled by CSCF 204. Once the call request is accepted by the PSAP 240, wireless device 220 generates device data and transmits to the PSAP 240. As noted above, device data may include data generated by wireless device 220 and/or data received by wireless device 220 from one or more external devices 221. External device 221 will be described in this example as a single device for ease of description. However, it should be noted that system 200 may include a plurality of external devices 221 communicably coupled to the wireless device 220. For example, device data may include data from sensors of wireless device 220, such as movement of the device gathered from an accelerometer of the wireless device 220, and/or data received from an external device 221, such as biometric data for the user gathered by a smartwatch or other mobile devices being worn by the user.

In this example, CSCF 204 transmits an SOS INVITE request to PSAP 240 with the device data. As used herein, an “SOS” request is an SIP request that includes specific markers to indicate that the connection is an emergency call. For example, the SOS INVITE may be an SIP INVITE request with an emergency marking, which CSCF 204, based on the emergency marking, routes the connection through emergency call session control function (E-CSCF) to ensure priority of the connection and routing to the correct PSAP 240. The SOS INVITE may include session description protocol (SDP) information describing the device data being transmitted. In examples, device data may be transmitted using real-time transport protocol (RTP) or secure real-time transport protocol (SRTP). AS 205 may be used in conjunction with SDP and RTP/SRTP to handle device data such as sensor data and biometric data for the transmission through SOS INVITE.

While the voice connection with PSAP 240 is ongoing, wireless device 220 is configured to generate a second set of device data, which may include data received from one or more external devices. In this example, once the second set of device data is generated, wireless network 202 transmits an SOS UPDATE to PSAP 240 with the second set of device data. It should be noted that a third set, a fourth set, and so on, may be generated by wireless device 220. For example, wireless device 220 may transmit new sets of device data whenever data generated changes from previous data generated. For example, changes in device temperature may trigger new transmissions.

To minimize the amount of data transmitted, new sets of device data may be transmitted based on preset triggers, or threshold changes in the data generated. For example, constant transmission of minor biometric changes would likely cause unnecessary data to be provided to emergency services. As such, in an example, device data may only be transmitted if the change in the biometric data meets, or exceeds, a preset threshold. In some embodiments, the threshold may be a time period. For example, device data may be transmitted based on the absence of voice transmission for a set amount of time, such after the user not providing any voice for a period of time the wireless device 220 may transmit biometric data showing the user’s vitals. In this example situation, a person may have become unconscious, thus unable to provide verbal feedback, so first responders may need to rely on sensor data for the person’s health information while help is on the way.

In some embodiments, device data may be transmitted based on triggers, such as data generated from sources not previously used or sources previously used no longer being available. For example, if wireless device 220 stops receiving biometric data from an external device 221, the device data lacking the biometric data may be transmitted to the PSAP 240. In other examples, when movement of device had been generated previously, but the new data shows as the device no longer moving, the lack of movement may be a trigger to transmit to PSAP 240, which could indicate that the user of the device is no longer conscious. The triggers and threshold are provided only as nonlimiting examples, as such triggers and threshold may include examples not described herein. As it is noted above, new sets of device data, which may include data received from external devices 221, may continue to be generated throughout the duration of the voice session established with PSAP 240. In some examples, the sets of data are generated and transmitted based on triggers and thresholds being met. It should be noted that in some cases the system 200 may not generate the SOS UPDATE, such as in situations where no thresholds or triggers are met for transmitting updated device data. Updated device data will be described in further detail in reference to FIG. 3.

Although SOS INVITE and SOS UPDATE are described as the SIP communication used for transmitting voice and device data, it should be noted that they are provided as examples without limitation. For example, in some situations, new sets of device data may be transmitted using SIP REINVITE.

Now referring to FIG. 3, an example decision flow 300 is presented. In this example, the flow begins, at step 301, by a wireless device generating device data. As noted above, the device data may include sensor data, such as user sensor data and environment sensor data. For example, the device data may include a plurality of sensor data such as the internal temperature of the device, GPS location of the device, movement of the device (e.g. data generated from an accelerometer), and the like.

In some embodiments, the wireless device may generate the device data by using data received from an external device. For example, the wireless device may receive biometric data from a device, such as a smartwatch, that is being worn by a user.

The flow continues at step 302 by the wireless device transmitting an emergency call request and the device data to a PSAP using a wireless network, where the device data is transmitted using SIP managed by a mobile network operator (MNO) of the wireless network. In an example, as described in reference to FIG. 2, device data may be transmitted using an SOS INVITE.

At step 303, once the wireless network receives the call request and device data, the wireless network proceeds with forwarding the emergency call request and the device data, using SIP, to PSAP. As described in reference to FIG. 2, the device data may be processed and formatted at either the wireless network or the PSAP.

During the call established with the PSAP, at step 304, if there is no update in the device data, then the flow ends. However, if there are updates in the device data, then at step 305 the flow includes transmitting the updated device data to the PSAP using SIP managed by the MNO of the wireless network. In an example, as described in reference to FIG. 2, the updated device data may be transmitted using an SOS UPDATE. Update in device data may be based on set thresholds for changes in the generated device data. For example, drastic changes in temperature generated by sensors may indicate worsening of an emergency, such as a fire related emergency. In some embodiments, update in device data may include no data being generated by one or more sensors for a set period of time. For example, lack of movement of the wireless device after a threshold period may indicate that the user of the device may have become unconscious. In some embodiments, the threshold of time may be based on the voice data. For example, after a set period of time without voice being transmitted by the user, the wireless device may transmit device data, such as biometric data. It should be noted that an update in device data may include any type of deviation from the device data generated at step 301.

Once the updated device data is transmitted by the wireless device, the flow continues by forwarding of updated device data by wireless network, using SIP, to the PSAP. It should be noted that step 305 is a loop, shown by dashed line, that may continue for the entire duration of the emergency call. In other words, as long as there are changes in the device data, or trigger/thresholds are met, the flow will continue by repeating steps 305 and 306. For example, if no voice is being transmitted by the user, but the voice session is still ongoing, the wireless device may continuously transmit updated device data for the duration of the call.

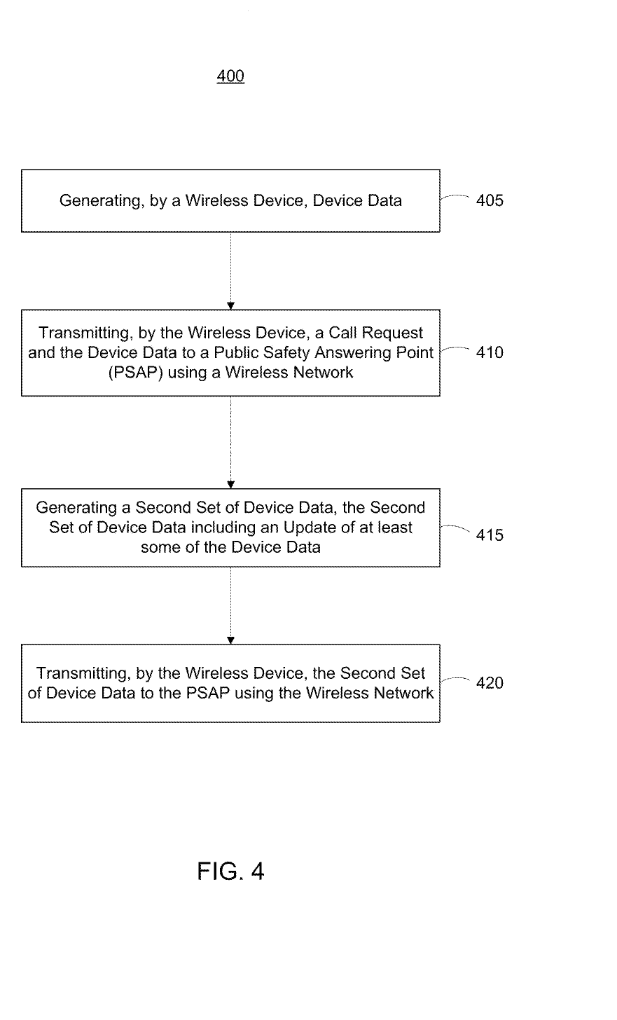

Now referring to FIG. 4, an example flow diagram of a method 400 for transmitting a wireless device sensor data is presented. At step 405, method 400 includes generating device data by a wireless device, such as wireless device 120/220. In embodiments, device data may be generated using data received from one or more external devices, such as external devices 121/221. In some embodiments, device data may include sensor and/or media data. For example, device data may include sensor data from an accelerometer and video data from a camera communicatively coupled to wireless device.

The method 400, at step 410, includes transmitting, by the wireless device, a call request and the device data to a public answering point (PSAP) using a wireless network, such as wireless network 202 and PSAP 240. In embodiments, transmitting the call request and device data may include using SIP INVITE. In embodiments, the SIP INVITE may be an SOS INVITE. In embodiments, transmitting the device data may include a session description protocol (SDP). In embodiments, transmitting the device data may include using real-time transport protocol (RTP). In embodiments, transmitting the device data may include using secure real-time transport protocol (SRTP). In some embodiments, device data may be processed by an application server within the wireless network. In embodiments, device data may be processed by an application server located at the PSAP.

At step 415, method 400 may include generating a second set of device data that includes an update of at least some of the device data. At step 420, method 400 may include transmitting, by the wireless device, the second set of device data to the PSAP using the wireless network. In some embodiments, the second set of device data may be transmitted based on a preset threshold. In some embodiments, the second set of device data may be transmitted based on a trigger.

In some embodiments, method 400 may include transmitting the second set of device data using SIP UPDATE. In embodiments, the SIP Update may be an SOS UPDATE. In embodiment, the second set of device data may be an SDP payload carried by a SIP UPDATE. In some embodiments, method 400 may include generating and transmitting subsequent sets of device data after transmission of the second set of device data. Similar to noted above, method may continue to generate and transmit sets of device data for the duration of the call generated by the call request.

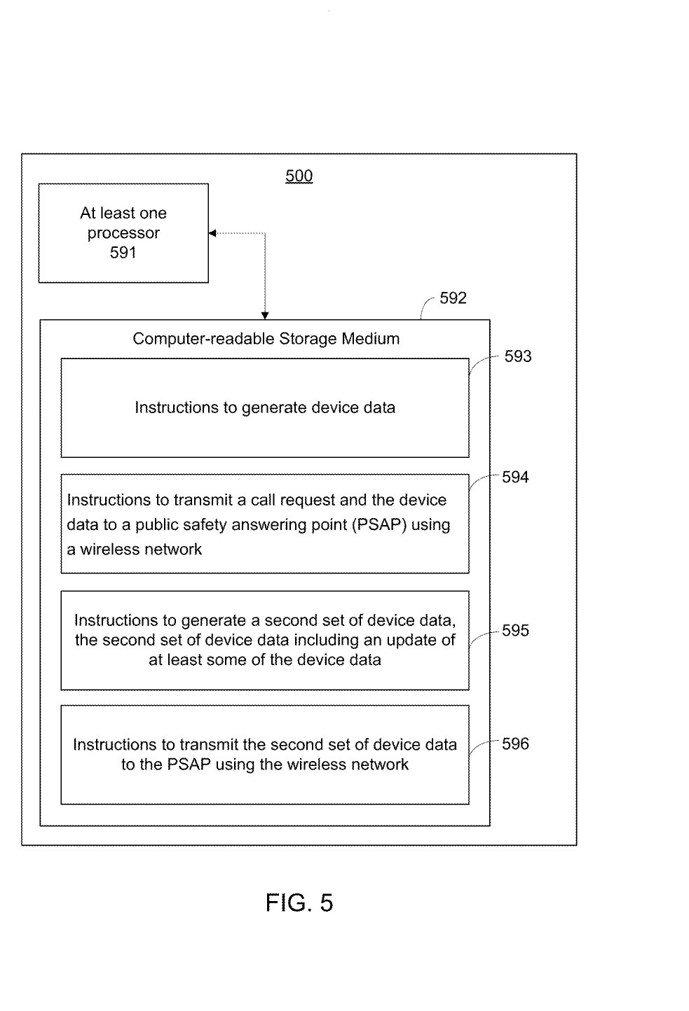

Now referring to FIG. 5, an example computing device 500 is presented. In this example, computing device 500 includes at least one processor 591 communicably coupled to a computer-readable storage medium 592. The at least one processor 591 may include a microprocessor, a microcontroller, one or more central processing unit (CPU) cores, an application-specific integrated circuit (ASIC), one or more graphical processing unit (GPU) cores, a field programmable gate array (FPGA), and/or any other hardware device suitable for retrieval and execution of instructions from computer-readable storage medium 592. In instances, at least one processor 591 may include electronic circuitry for performing instructions described in this disclosure.

In instances, computer-readable storage medium 592 may be any medium suitable for storing executable instructions. In examples, without limitation, computer-readable storage medium 592 may include read-only memory (ROM), random-access memory (RAM), erasable electrically programmable ROM (EEPROM), Solid State Drive (SSD), optical disc, and the like. Computer-readable medium storage 592 may be disposed within computing device 500. In embodiments, computer-readable storage medium 592 may external, and communicably connected, to computing device 500. The instruction stored on computer-readable storage medium may be used to implement method steps described in reference to FIG. 4.

In this example, computer-readable storage medium 592 is encoded with set of instructions 593 and 594. In embodiments, computer-readable storage medium 592 may be further encoded with set of instructions 595 and 596. In embodiments, executable instructions included in each block may be included in different blocks shown and blocks not shown.

Instruction 593, when executed by at least one processor 591, configures the at least one processor 591 to generate device data.

Instruction 594, when executed by at least one processor 591, configures the at least one processor 591 to transmit a call request and the device data to a PSAP using a wireless network. The wireless network may be consistent with, or include, network components described in reference to FIGS. 1 and 2, such as wireless network 202.

In some embodiments, instruction 595, when executed by at least one processor 591, configures the at least one processor 591 to generate a second set of device data. In embodiments, instruction 596, when executed by at least one processor 591, configures the at least one processor 591 to transmit the second set of device data to the PSAP using the wireless network. In embodiments, the at least one processor 591 may be configured to generate and transmit sets of device data subsequent to the second set of device data.

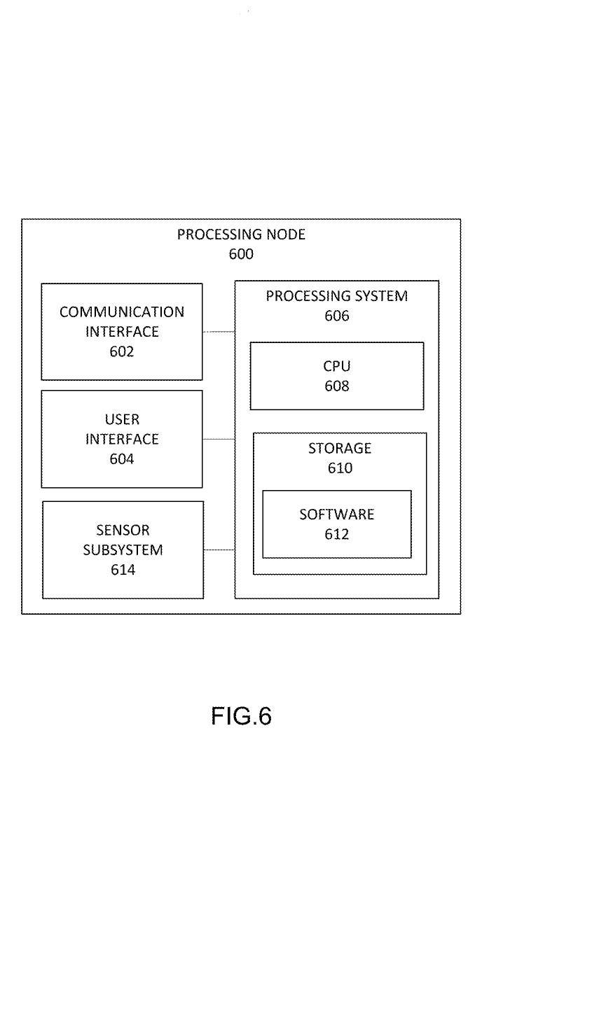

Now referring to FIG. 6, an example processing node 600, which may be configured to perform the methods and operations disclosed herein for selective attestation for emergency calls. The processing node 600 includes a communication interface 602, user interface 604, and processing system 606 in communication with communication interface 602 and user interface 604. Communication interface 602 may include hardware components, such as network communication ports, devices, routers, wires, antenna, transceivers, etc. User interface 604 may include hardware components, such as touch screens, buttons, displays, speakers, etc.

Processing system 606 includes a central processing unit (CPU) or processor 608, storage 610 and sensor subsystem 614. Storage 610 may include a disk drive, flash drive, memory circuitry, or other memory device including, for example, a buffer. Storage 610 can store software 612 which is used in the operation of the processing node 600. Software 612 may include computer programs, firmware, or some other form of machine-readable instructions, including an operating system, utilities, drivers, network interfaces, applications, or some other type of software. Processing system 606 may include a processor 608 and other circuitry to retrieve and execute software 612 from storage 610, which may be internal or external to the processing system 606. Sensor subsystem 614 may include a plurality of hardware sensors. Sensor subsystem 614 may include positioning sensors, such as proximity sensors and GPS, accelerometers, gyroscopes, magnetometers, barometers, thermometers, biometric sensors, such as heart rate monitors and blood oxygen sensor, and the like. In examples, software 612 may include computer programs used for gathering sensor data from sensor subsystem 614, such as sensor drivers. Processing node 600 may further include other components such as a power management unit, a control interface unit, etc., which are omitted for clarity. Communication interface 602 permits processing node 600 to communicate with other network elements. User interface 604 permits the configuration and control of the operation of processing node 600. Processing node 600 may be included in various elements of the wireless network including an access node, proxy call session control function (P-CSCF), emergency call session control function (E-CSCF), gateway mobile location center (GMLC), secure telephone identity authentication service (STI-AS), session border controller (SBC), or PSAP for example. In this example, software 612 may include the instructions described in reference to FIG. 5.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not all be within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method, the method comprising:
generating, by a wireless device, device data; and
transmitting, by the wireless device, a call request and the device data to a public safety answering point (PSAP) using a wireless network.

2. The method of claim 1, wherein the call request is a session initiated protocol (SIP) invite.

3. The method of claim 2, wherein the device data is session description protocol (SDP) carried by the SIP invite.

4. The method of claim 3, wherein the SIP invite is an SOS invite.

5. The method of claim 3, wherein the device data comprises sensor or media data.

6. The method of claim 3, further comprising generating a second set of device data subsequent to the transmission of the call request and the device data to the PSAP, the second set of device data including an update of at least some of the device data.

7. The method of claim 6, further comprising transmitting the second set of device data to the PSAP using the wireless network.

8. The method of claim 6, wherein the second set of data is a session description protocol (SDP) payload carried by a session initiation protocol (SIP) UPDATE.

9. The method of claim 6, further comprising generating the second set of device data in response to a trigger comprising a change in sensor data or an absence of voice transmission after a time threshold.

10. A system, the system comprising:
a wireless network;
a computing device communicatively connected to the wireless network, wherein the computing device comprises at least one processor configured to:
generate device data; and
transmit a call request and the device data to a public safety answering point (PSAP) using the wireless network.

11. The system of claim 10, wherein the call request is a session initiated protocol (SIP) invite .

12. The system of claim 11, wherein the device data is session description protocol (SDP) carried by the SIP invite.

13. The system of claim 12, wherein the SIP invite is an SOS invite.

14. The system of claim 12, wherein the device data comprises sensor or media data.

15. The system of claim 14, wherein the computing device is further configured to generate a second set of device data subsequent to the transmission of the call request and the device data to the PSAP, the second set of device data including an update of at least some of the device data.

16. The system of claim 15, wherein the computing device is further configured to transmit the second set of device data to the PSAP using the wireless network.

17. The system of claim 15, wherein the second set of data is a session description protocol (SDP) payload carried by a session initiation protocol (SIP) UPDATE.

18. The system of claim 15, wherein the computing device is further configured to generate the second set of device data in response to a trigger comprising a change in sensor data or an absence of voice transmission after a time threshold.

19. A non-transitory computer-readable medium storing instructions, when executed by at least one processor, configuring the at least one processor to:
generate device data; and
transmit a call request and the device data to a public safety answering point (PSAP) using a wireless network.

20. The non-transitory computer-readable medium storing instructions of claim 19, wherein the at least one processor is further configured to generate a second set of device data subsequent to the transmission of the call request and the device data to the PSAP, the second set of device data including an update of at least some of the device data.
